(19) United States
(12) Patent Application Publication
(10) Pub. No.: US 2020/0072350 A1
(43) Pub. Date: Mar. 5, 2020

(54) ROTARY PARK LOCK

(71) Applicant: Schaeffler Technologies AG & Co. KG, Herzogenaurach (DE)

(72) Inventors: Chris Luipold, Wadsworth, OH (US); Christopher Shamie, Brighton, MI (US)

(73) Assignee: Schaeffler Technologies AG & Co. KG, Herzogenaurach (DE)

(21) Appl. No.: 16/522,756

(22) Filed: Jul. 26, 2019

Related U.S. Application Data
(60) Provisional application No. 62/727,297, filed on Sep. 5, 2018.

(51) Int. Cl. F16H 63/34; B60T 1/00; F16D 63/00; F16D 59/00

(52) U.S. Cl. CPC F16H 63/3425; B60T 1/005; F16D 63/006; F16D 2121/26; F16H 63/3475; B60Y 2400/421; F16D 59/00

(57) ABSTRACT

A rotary park lock mechanism includes a flange, a first spring, and a gear. The flange has a park pawl arranged to selectively engage a mating tooth in a transmission gear, and a locking bar pocket. The first spring is arranged to rotate the flange in a first rotational direction to engage the park pawl with the mating tooth. The gear is arranged receive a motor torque to rotate the flange in a second rotational direction, opposite the first direction, to disengage the park pawl from the mating tooth. In an example embodiment, the first spring is a clock spring. In an example embodiment, the gear is a cycloidal drive.

A park lock actuator is shown in commonly-assigned U.S. Patent Application No. 62/664,976 filed May 1, 2018 and titled ELECTRO-MECHANICAL PARK LOCK ACTUATOR, hereby incorporated by reference as if set forth fully herein. Another device is shown in United States Patent Application Publication No. 2018/050,668 titled PARK LOCK SYSTEM FOR A HYBRID ELECTRIC VEHICLE to Spaulding et al.

### TECHNICAL FIELD

The present disclosure relates generally to a rotary park lock mechanism, and more specifically to rotary park lock mechanism that fails to a park condition.

### BACKGROUND

### Summary

Example aspects of the disclosure broadly comprise a rotary park lock mechanism including a flange, a first spring, and a gear. The flange has a park pawl arranged to selectively engage a mating tooth in a transmission gear, and a locking bar pocket. The first spring is arranged to rotate the flange in a first rotational direction to engage the park pawl with the mating tooth. The gear is arranged receive a motor torque to rotate the flange in a second rotational direction, opposite the first direction, to disengage the park pawl from the mating tooth. In an example embodiment, the first spring is a clock spring. In an example embodiment, the gear is a cycloidal drive.

In some example embodiments, the rotary park lock mechanism has a locking bar and a second spring. The locking bar has a first distal end with a pin arranged to displace in a first axial direction to engage the locking bar pocket, a second distal end, opposite the first distal end, and a pivot disposed between the first distal end and the second distal end. The second spring is arranged to displace the second distal end in the first axial direction to disengage the pin from the locking bar pocket. In an example embodiment, the flange cannot rotate when the locking bar pin is disposed in the locking bar pocket.

In some example embodiments, the rotary park lock mechanism has a solenoid for displacing the second distal end in a second axial direction, opposite the first axial direction, to engage the pin in the locking bar pocket. In an example embodiment, the solenoid is arranged to displace the second distal end in the second axial direction when the solenoid is powered. In an example embodiment, the second spring is arranged to displace the second distal end in the first axial direction when the solenoid is not powered.

Other example aspects broadly comprise a rotary park lock mechanism for a vehicle transmission. In response to a power input, the rotary park lock mechanism is arranged to disengage a cog in a transmission gear, allowing rotation of a gear in the vehicle transmission and allowing motion of the vehicle. When the power input is removed, the rotary park lock mechanism is arranged to engage the cog in the transmission gear, preventing rotation of the gear in the vehicle transmission and preventing motion of the vehicle. In an example embodiment, the cog is engaged and disengaged through only rotary motion of the rotary park lock mechanism. In some example embodiments, the rotary park lock mechanism is held in a disengaged position by a solenoid. In an example embodiment, the power input is removed from the solenoid to engage the cog in the transmission gear.

### BRIEF DESCRIPTION OF THE DRAWINGS

FIG. 1 illustrates a front view of a rotary park lock mechanism in a park condition.

FIG. 2 illustrates a perspective section view the rotary park lock mechanism of FIG. 1.

FIG. 3 illustrates a front view of the rotary park lock mechanism of FIG. 1 in a drive condition.

FIG. 4 illustrates a perspective section view of the rotary park lock mechanism of FIG. 3.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

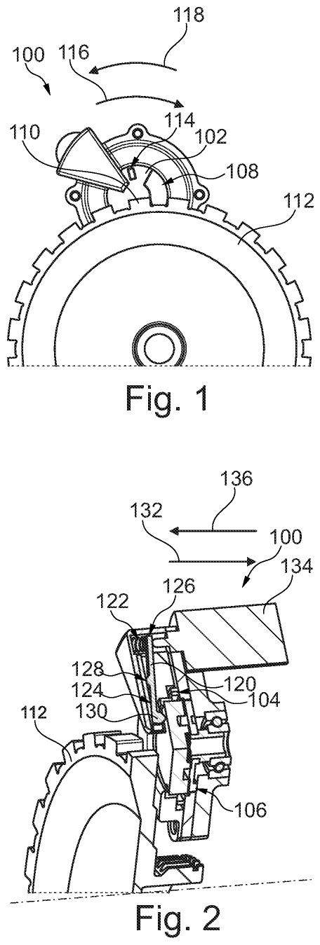

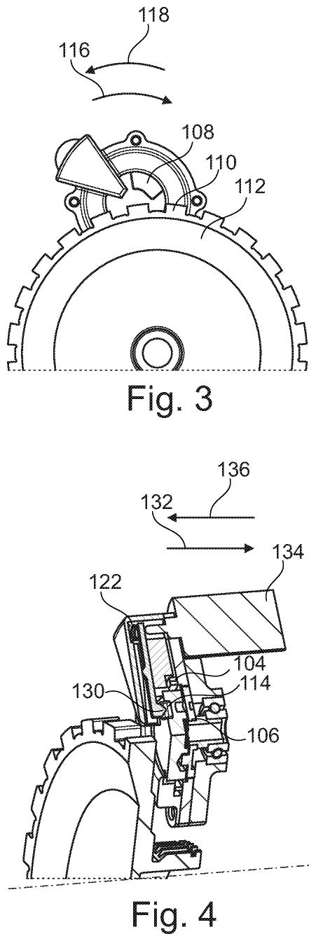

The following description is made with reference to FIGS. 1-4. FIG. 1 illustrates a front view of rotary park lock mechanism 100 in a park condition. FIG. 2 illustrates a perspective section view the rotary park lock mechanism of FIG. 1. FIG. 3 illustrates a front view of the rotary park lock mechanism of FIG. 1 in a drive condition. FIG. 4 illustrates a perspective section view of the rotary park lock mechanism of FIG. 3.

Rotary park lock mechanism 100 includes flange 102, spring 104, and gear 106. The flange includes park pawl 108, arranged to selectively engage mating tooth, or cog, 110 in transmission gear 112, and locking bar pocket, or groove, 114. The spring is arranged to rotate the flange in direction 116 to engage the park pawl with the mating tooth (as shown in FIG. 1). The gear is arranged receive a motor torque to rotate the flange in direction 118, opposite direction 116, to disengage the park pawl from the mating tooth (as shown in FIG. 3) and wind spring 104, storing energy. As can be appreciated, rotation of the flange by the spring also requires back driving the gear and the motor. In an example embodiment (not shown), mechanism 100 may include a disconnect clutch between pawl 108 and gear 106 to eliminate back driving the gear and motor with spring 104. Spring 104 may be a clock spring, for example. Gear 106 may be a cycloidal drive, for example.

Rotary park lock mechanism 100 includes locking bar 120 and spring 122. The locking bar includes distal end 124, distal end 126, opposite distal end 124, and pivot 128 disposed between distal ends 124 and 126. Distal end 124 has pin 130, arranged to displace in axial direction 132 to engage the locking bar pocket. Pivot 128 may include a bushing (not shown). Spring 122 is arranged to displace distal end 126 in axial direction 132 to disengage the pin from the locking bar pocket. Flange 102 cannot rotate when the locking bar pin is disposed in the locking bar pocket.

Rotary park lock mechanism 100 includes solenoid 134 for displacing distal end 126 in axial direction 136, opposite axial direction 132, to engage the pin in the locking bar pocket. The solenoid is arranged to displace distal end 126 in axial direction 136 when the solenoid is powered. Spring 122 is arranged to displace distal end 126 in axial direction 132 when the solenoid is not powered.

In other words, in response to a power input, the rotary park lock mechanism is arranged to disengage a cog in a transmission gear as shown in FIGS. 3-4, allowing rotation of a gear in the vehicle transmission and allowing motion of the vehicle. When the power input is removed, the rotary park lock mechanism is arranged to engage the cog in the transmission gear as shown in FIGS. 1-2, preventing rotation of the gear in the vehicle transmission and preventing motion of the vehicle. Power may be removed by the vehicle in response to a park command, or to a power failure at the rotary park lock mechanism or one of its components (e.g., the solenoid). As described above, the cog is engaged and disengaged through only rotary motion of the rotary park lock mechanism. The rotary park lock mechanism is held in a disengaged position, and disengagement energy held in spring 104, by solenoid 134. The power input is removed from the solenoid to release the spring energy and engage the cog in the transmission gear as shown in FIGS. 1-2.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Park lock mechanism
102 Flange
104 Spring (clock)
106 Gear (cycloid)
108 Park pawl
110 Mating tooth
112 Transmission
114 Locking bar pocket
116 Rotational direction (first)
118 Rotational direction (second)
120 Locking bar
122 Spring
124 Distal end (first)
126 Distal end (second)
128 Pivot
130 Pin
132 Axial direction (first)
134 Solenoid
136 Axial direction (second)

What is claimed is:

1. A rotary park lock mechanism, comprising:
a flange comprising:
a park pawl arranged to selectively engage a mating tooth in a transmission gear; and,
a locking bar pocket;
a first spring arranged to rotate the flange in a first rotational direction to engage the park pawl with the mating tooth; and,
a gear arranged receive a motor torque to rotate the flange in a second rotational direction, opposite the first direction, to disengage the park pawl from the mating tooth.

2. The rotary park lock mechanism of claim 1 wherein the first spring is a clock spring.

3. The rotary park lock mechanism of claim 1 wherein the gear is a cycloidal drive.

4. The rotary park lock mechanism of claim 1 further comprising:
a locking bar comprising:
a first distal end comprising a pin arranged to displace in a first axial direction to engage the locking bar pocket;
a second distal end, opposite the first distal end; and,
a pivot disposed between the first distal end and the second distal end; and,
a second spring arranged to displace the second distal end in the first axial direction to disengage the pin from the locking bar pocket.

5. The rotary park lock mechanism of claim 4 wherein the flange cannot rotate when the locking bar pin is disposed in the locking bar pocket.

6. The rotary park lock mechanism of claim 4 further comprising a solenoid for displacing the second distal end in a second axial direction, opposite the first axial direction, to engage the pin in the locking bar pocket.

7. The rotary park lock mechanism of claim 6 wherein the solenoid is arranged to displace the second distal end in the second axial direction when the solenoid is powered.

8. The rotary park lock mechanism of claim 6 wherein the second spring is arranged to displace the second distal end in the first axial direction when the solenoid is not powered.

9. A rotary park lock mechanism for a vehicle transmission, wherein:
in response to a power input, the rotary park lock mechanism is arranged to disengage a cog in a transmission gear, allowing rotation of a gear in the vehicle transmission and allowing motion of the vehicle; and,
when the power input is removed, the rotary park lock mechanism is arranged to engage the cog in the transmission gear, preventing rotation of the gear in the vehicle transmission and preventing motion of the vehicle.

10. The rotary park lock mechanism of claim 9 wherein the cog is engaged and disengaged through only rotary motion of the rotary park lock mechanism.

11. The rotary park lock mechanism of claim 9 wherein the rotary park lock mechanism is held in a disengaged position by a solenoid.

12. The rotary park lock mechanism of claim 11 wherein the power input is removed from the solenoid to engage the cog in the transmission gear.
